(19) United States
(12) Patent Application Publication
(10) Pub. No.: US 2026/0040303 A1
(43) Pub. Date: Feb. 5, 2026

(54) MEDIUM ACCESS CONTROL FOR RELAYING AMBIENT COMMUNICATION

(71) Applicant: Apple Inc., Cupertino, CA (US)

(72) Inventors: Zhibin Wu, Los Altos, CA (US); Naveen Kumar R. Palle Venkata, San Diego, CA (US); Peng Cheng, Beijing (CN); Alexander Sirotkin, Tel Aviv (IL); Fangli Xu, Beijing (CN); Yuqin Chen, Beijing (CN); Ping-Heng Kuo, London (GB); Haijing Hu, Los Gatos, CA (US)

(73) Assignee: Apple Inc., Cupertino, CA (US)

(21) Appl. No.: 19/246,676

(22) Filed: Jun. 23, 2025

Related U.S. Application Data
(60) Provisional application No. 63/677,958, filed on Jul. 31, 2024.

(51) Int. Cl. H04W 72/1268; H04W 72/0453; H04W 72/21; H04W 72/566

(52) U.S. Cl. CPC H04W 72/1268; H04W 72/0453; H04W 72/21; H04W 72/566

(57) ABSTRACT

The present application relates to devices and components, including apparatus, systems, and methods for scheduling the relaying of ambient Internet-of-things (A-IoT) traffic by a user equipment (UE).

### CROSS-REFERENCE TO OTHER APPLICATION

This application claims priority to U.S. Provisional Patent Application No. 63/677,958, for “MEDIUM ACCESS CONTROL FOR RELAYING AMBIENT COMMUNICATION” filed on Jul. 31, 2024, which is herein incorporated by reference in its entirety for all purposes.

### FIELD

This application relates generally to communication networks and, in particular, to scheduling relaying ambient-Internet-of-thing (A-IoT) traffic by a user equipment (UE).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates two topologies for components of the network environment in accordance with some embodiments.

FIG. 3 illustrates protocol stacks of components of the network environment to support A-IoT traffic in accordance with some embodiments.

FIG. 4 illustrates two communication schemes between a reader and devices in accordance with some embodiments.

FIG. 5 illustrates control signaling formats in accordance with some embodiments.

FIG. 6 illustrates a network environment in accordance with some embodiments.

FIG. 7 illustrates two prioritization protocols in accordance with some embodiments.

FIG. 8 illustrates an operation flow/algorithmic structure in accordance with some embodiments.

FIG. 9 illustrates another operation flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

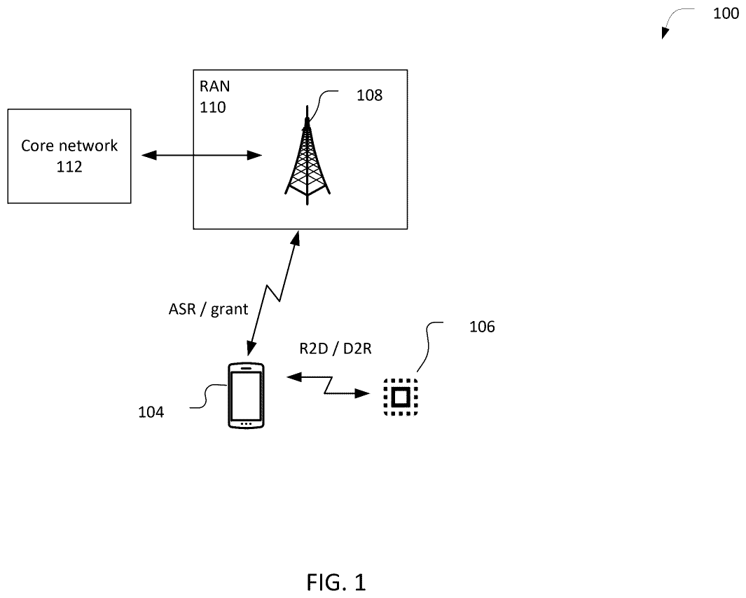

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support the transmission of data over a wireless link between the two nodes.

The network environment 100 may further include a core network 112. For example, the core network 112 may comprise a 5^{th} Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include an A-IoT device 106. The A-IoT device 106 may also be referred to as a device or a tag. The A-IoT device 106 may be a low-complexity, low-power consumption device with limited or no energy storage capabilities. The A-IoT device 106 may depend on various ambient energy sources. For example, the A-IoT device 106 may obtain energy from sources such as, but not limited to, radio-frequency signals, solar, kinetic/vibration, electromagnetic, electrostatic, thermal energy, thermoelectric, magnetic, wind, water, or acoustic sources. In some embodiments, the A-IoT device 106 may be similar to that described in the Third Generation Partnership Project (3GPP) Technical Report (TR) 38.848, v18.0.0 (2023 Sep. 29).

The A-IoT device 106 may communicate with a network node (e.g., base station 108 or UE 104), which may be referred to as a reader, to perform various inventory, sensor, positioning, or command operations.

The A-IoT device 106 may be a Type 1 device or a Type 2 device. A Type 1 device may have low power consumption, and Type 2 may have higher power consumption than Type 1 but also may have the capability to store energy. For example, a Type 1 device may have: a peak power consumption of approximately 1 ρW; energy storage; an initial sampling frequency offset (SFO) of up to 10^{x} parts per million (PPM); and neither downlink nor uplink amplification. Uplink transmission from a Type 1 device may be performed by backscattering a carrier wave (CW) provided by another device. A Type 2 device may have: a peak power consumption of less than or equal to a few hundred W; energy storage; an initial SFO of up to 10^{X} ppm; and downlink or uplink amplification. An uplink transmission from a Type 2 device may be generated internally by the device or be backscattered on a CW provided by another device.

In some instances, the A-IoT device 106 may not generate its own radio signals. Instead, it may modulate and reflect an incident carrier waver generated by a reader (e.g., base station 108 or UE 104) to communicate. The reader (e.g., base station 108 or UE 104) may transmit a continuous or intermittent carrier waver towards the A-IoT device 106. The A-IoT device 106 may modulate this carrier waver with its data by changing the impedance of its antenna. This modulation may be achieved through methods such as load modulation or reflection modulation. The modulated wave is then backscattered (e.g., reflected) to the reader (e.g., the base station 108 or UE 104) carrying the information of the A-IoT device 106 information.

In some instances, UE 104 may receive and process information for one or more A-IoT devices (e.g., A-IoT device 106). UE 104 may receive information from base station 108 or core network 112 through a non-access stratum (NAS) container. UE 104 may buffer the received information. The traffic between UE 104 and core network 112 that is encapsulated in the NAS container may not be accessible or known to the base station 108. Accordingly, base station 108 may not schedule UE 104 reader transmission unless the UE 104 reader reports the traffic.

To inform base station 108 of UE 104 traffic to A-IoT devices (e.g., A-IoT 106), in some embodiments, when UE 104 identifies buffered data for A-IoT devices (e.g., A-IoT device 106), it may trigger requesting resources, e.g., time or frequency resources, for transmitting the buffered data to the corresponding A-IoT devices (e.g., A-IoT device 106). UE 104 may generate and transmit an A-IoT scheduling request (ASR) to base station 108. UE 104 may generate ASR for reader-initiated transmission. UE 104 may send ASR to base station 108 to report statistics of how much data (towards A-IoT devices) is buffered in UE 104.

In some embodiments, base station 108 may receive and process the ASR from the UE 104, generate a reader-to-device (R2D) grant, and transmit it to the UE 104. The R2D grant may include resources, e.g., time and frequency resources, allocated for transmission from the reader (e.g., UE 104) to the device (e.g., A-IoT device 106). The ASR may indicate A-IoT buffer status, e.g., the size of buffered data or latency associated with the buffered data. The content of the buffer status in the ASR may be similar to the content of the buffer status report (BSR) described in 3GPP TSs.

In some instances, the UE 104 may receive an uplink grant, allocating resources for uplink transmission to the base station 108. The uplink grant may collide with the R2D grant, e.g., the resources allocated for uplink transmission overlap with those allocated by the R2D grant for R2D transmission.

In some embodiments, UE 104 may apply the prioritization rule to resolve the collision between an uplink grant and an R2D grant. For example, when the intermediate reader node, e.g., UE 104, is scheduled to send both uplink transmission and A-IoT downlink traffic, e.g., from UE 104 to A-IoT device 106, and the UE 104 is not capable of performing both transmissions, UE 104 may choose or select one of the transmissions based on a prioritization rule.

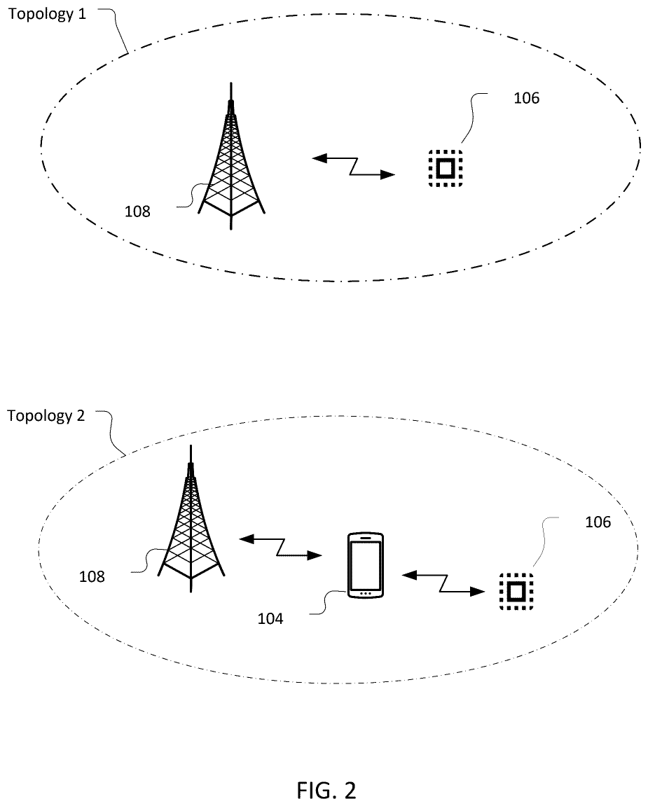

FIG. 2 illustrates components of the network environment 100 in various topologies in accordance with some embodiments.

In Topology 1, the base station 108 operates as the reader and communicates directly and bidirectionally with the A-IoT device 106. A-IoT data/signaling may be transmitted in the uplink or the downlink. In some instances, the base station transmitting to the A-IoT device 106 may be different from a base station receiving from the A-IoT device 106. In Topology 1, the base station 108 and the A-IoT device 106 may both be located indoors.

In Topology 2, the A-IoT device 106 may communicate bidirectionally with the UE 104, which operates as the reader. The UE 104 may be coupled with the base station 108 and may be under network control for A-IoT operations. A-IoT data/signaling may be exchanged over an A-IoT air interface between the UE 104 and the A-IoT device 106 and over a Uu interface between the UE 104 and the base station 108. In Topology 2, the UE 104 may also be referred to as an intermediate node. In various embodiments, the UE 104 may be a device such as a mobile phone, a relay, a repeater, a dedicated reader, etc. The UE 104 and the A-IoT device 106 may both be located indoors, while the base station 108 is located outdoors.

There may be three types of application-layer traffic with respect to A-IoT communications: device terminated (DT), device originated (DO)-DT triggered (DO-DTT) and DO-autonomous (DO-A).

DT traffic may be relevant to a command use case in which the reader sends a command to the A-IoT device 106. The reader, for example, the UE 104 or the base station 108, sends a transmission in the downlink channel. No external CW generation is needed, nor is there a need for access stratum (AS) layer acknowledgment. The AS layer transmission may be triggered by a core network (CN)-initiated message in Topology 1 or upper layers of UE 104 or CN-initiated message in Topology 2.

DO-DTT may be relevant to an inventory use case. Application layer transactions may be bidirectional, for example, from the reader to A-IoT device 106 or from A-IoT device 106 to the reader. The lower-layer transmission scheme may rely on a backscattered CW (in which case external CW generation may be needed) or an internally generated CW (in which case no external CW generation is needed). The AS layer acknowledgment may not be needed. The AS layer transmission may be triggered by processed DT trigger or DO traffic being generated and available.

DO-A may be relevant to a sensor use case. Application layer transactions may be initiated from the A-IoT device 106 to the reader. The lower-layer transmission scheme may rely on a backscattered CW (in which case external CW generation may be needed) or an internally generated CW (in which case no external CW generation is needed). The AS layer transmission may be triggered when the upper layer of the A-IoT device 106 has made DO traffic available. There may be some restrictions on AS layer triggering in some instances.

Embodiments of the present disclosure describe the user-plane (UP) protocol stack on the UE 104 to enable the UE 104 acting as an intermediate node, handling A-IoT end-to-end traffic. Some aspects describe network-assisted scheduling for reader-initiated R2D transmission where UE 104 sends an ASR to the base station 108 to request resources for an R2D transmission, and base station 108 sends an R2D grant to UE 104, allocating resources for the R2D transmission.

With reference to a 3GPP Release 17 UE-to-NW Relay design, a Layer 2 relay design assumes an end-to-end (e2e) AS layer connection (at packet data convergence protocol (PDCP) layer) between a base station and remote UE through a relay UE, while a Layer 3 relay design does not have an end-to-end connection and, instead, relies on an IP relay in intermediate node (L3 U2N relay). The PDCP layer may not be provided for A-IoT communications in the A-IoT device 106. Thus, there may not be a similar e2e AS layer connection.

In NAS-based communication, a Uu NAS connection between the UE 104 (operating as a reader) and an access mobility and management function (AMF) of the core network 112 may be used to encapsulate A-IoT data or control traffic. A signaling radio bearer (SRB) over the Uu interface between the UE 104 and the base station 108 may be used as a relay. The SRB may be dedicated to A-IoT traffic or may be shared with other traffic. For example, SRB2, which is used for NAS messages, may be configured to carry A-IoT traffic. The A-IoT uplink data may be delivered to an A-IoT Application Function or other core network entities.

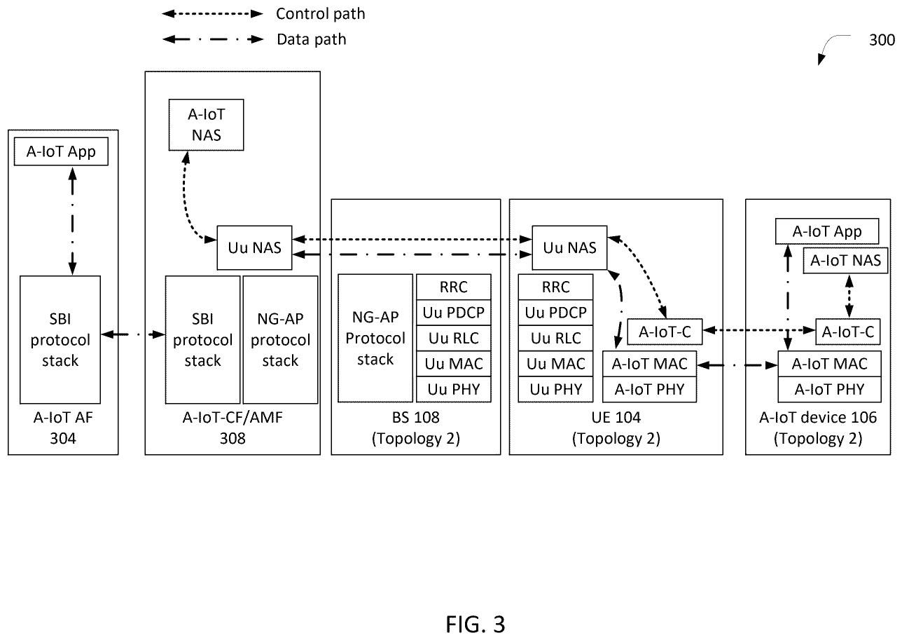

FIG. 3 illustrates protocol stacks 300 of components of the network environment 100 in accordance with some embodiments of the first option.

The A-IoT device 106 may include an A-IoT application (app) layer that is coupled with an A-IoT MAC layer via data path. The A-IoT device 106 may include an A-IoT NAS layer and an A-IoT control (A-IoT-C) layer.

With respect to Topology 2, the A-IoT-C layer of the A-IoT device 106 may be coupled with a corresponding A-IoT-C layer of the UE 104 (acting as an intermediate node) via a control path; and the A-IoT MAC layer of the A-IoT device 106 may be coupled with a corresponding A-IoT MAC layer of the UE 104 via a data path.

For A-IoT traffic, the A-IoT MAC layer of the UE 104 may be coupled with a Uu NAS layer of the UE 104 via a data path, and the A-IoT-C layer of the UE 104 may be coupled with the Uu NAS layer of the UE 104 via a control path. The Uu NAS layer of the UE 104 may be coupled with a Uu NAS layer of the A-IoT-CF/AMF 308 of the core network 112 via data and control paths. The Uu NAS layer of the A-IoT-CF/AMF 308 may further communicate with an A-IoT NAS layer of the A-IoT-CF/AMF 308 via an internal control interface within the A-IoT CF-AMF 308 itself. The A-IoT-CF/AMF 308 may include a service-based interface (SBI) protocol stack that is coupled with a corresponding SBI protocol stack in the A-IoT AF 304 by a data path. The SBI protocol stack in the A-IoT AF 304 may be coupled with the A-IoT application layer of the A-IoT AF 304 by a data path.

For UL traffic, the UE 104 may receive an A-IoT data PDU from the A-IoT MAC layer of the A-IoT device 106. The UE 104 may remove the A-IoT MAC header and determine, based on information in the header, a destination device for the A-IoT data, for example, the A-IoT AF 304. The Uu NAS layer of the UE 104 may then create a NAS container with the received A-IoT data PDU along with PDU type information and A-IoT device ID associated with the destination device.

In some embodiments, the AS layer may be requested to carry the A-IoT traffic in the NAS container via the Uu UL interface. The A-IoT traffic may be conveyed over the Uu UL interface by an SRB2 or an SRB defined for A-IoT purposes.

For DL traffic, the UE 104 may receive a NAS message container from base station 108 in an SRB2 or a new SRB defined for A-IoT purposes. The Uu NAS layer may determine if the NAS message container indicates it is for A-IoT. If the NAS message container includes an A-IoT data PDU, the A-IoT data PDU may be retrieved from the NAS message container and provided to the A-IoT MAC layer, which creates a MAC PDU. The MAC PDU may be created with a MAC header filled with desired information (e.g., device identifier (ID) associated with A-IoT device 106). The A-IoT MAC layer may then transmit the MAC PDU in the A-IoT air interface towards the A-IoT device 106 (or devices).

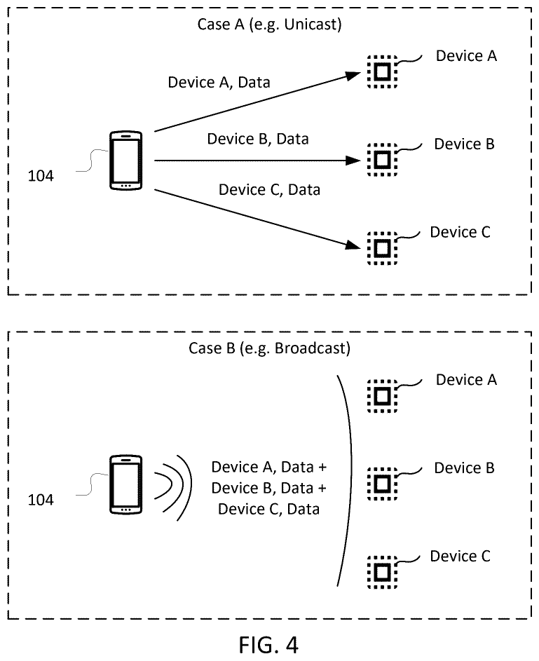

FIG. 4 illustrates two communication schemes between a reader and devices in accordance with some embodiments.

The UE 104 reader may have buffered data from devices A, B, and C. Two communication schemes may be used to transfer buffered data to corresponding devices. Two communication schemes include case A, unicast communication, and case B, broadcast communication.

In case A, e.g., unicast communication, UE 104 may transmit each device's data in a separate transmission. For example, UE 104 may send data of device A in a first transmission, data of device B in a second transmission, and data of device C in a third transmission. These transmissions may use different time and frequency resources. Traffic to different destinations, e.g., A-IoT devices, may be scheduled in separate packets. In one example, the packets carrying the traffic to an A-IoT device may be a medium access control (MAC) PDU or a transport block. In case A, separate MAC PDU or separate TB that are delivered separately may carry traffic to devices A, B, or C. In order to support this case, the NW may allocate different separate resources for UE to transmit to respective A-IoT devices.

To obtain resources for R2D transmissions, UE 104 may send an ASR to base station 108. In some embodiments, UE 104 may send one ASR requesting one or more R2D grants for transmitting data from the UE 104 to devices A, B, or C. In some embodiments, UE 104 may send a separate ASR for each R2D grant. In some embodiments, one ASR may be used to request R2D grants for each of the A-IoT devices with buffered data traffic. Base station 108 may include all the R2D grants in one message or may use multiple messages to send R2D grants for each of the requested R2D grants.

In case B, e.g., broadcast, UE 104 may have traffic to different devices in the same packet in an R2D transmission. UE 104 may transmit buffered data to destination A-IoT devices A, B, and C in a single transmission. All the A-IoT devices, A, B, and C, may receive the transmission, and each may receive and process its corresponding data. For example, UE 104 may generate a packet that includes the data for devices A, B, and C and send the packet to devices A, B, and C in one transmission. Devices A, B, and C may receive the transmission; each may process and receive a copy of the packet. Each device may obtain its data from the received copy of the packet, e.g., device A may obtain device A data from the received packet, device B may obtain device B data from the received packet, and device C may obtain device C data from the received packet.

To obtain resources for R2D transmission, UE 104 may send an ASR to base station 108. The UE may send one ASR requesting an R2D grant. The ASR may include an indication of the size of data or the number of destinations. For example, for Case A, it is necessary for UE to indicate the number of different destinations in the ASR message so that base station 108 can allocate the number of separate R2D resources correspondingly.

In some instances, the UE 104 may perform traffic aggregation. For example, the UE 104 may wait for a threshold volume of A-IoT data or A-IoT data from a threshold number of devices that may be aggregated and sent together. For example, the ASR is only triggered when the aggregated data available reaches or exceeds the threshold.

In some instances, the buffer size (e.g., size of data in bits or bytes) is small for each destination device, e.g., devices A, B, or C. A smaller range of buffer size indices may be used to indicate the buffer size. In some cases, the buffer size may not be explicitly included in the ASR. Including a destination device in the ASR, explicitly or implicitly (e.g., in the total number of destinations), may indicate a default buffer size associated with that device.

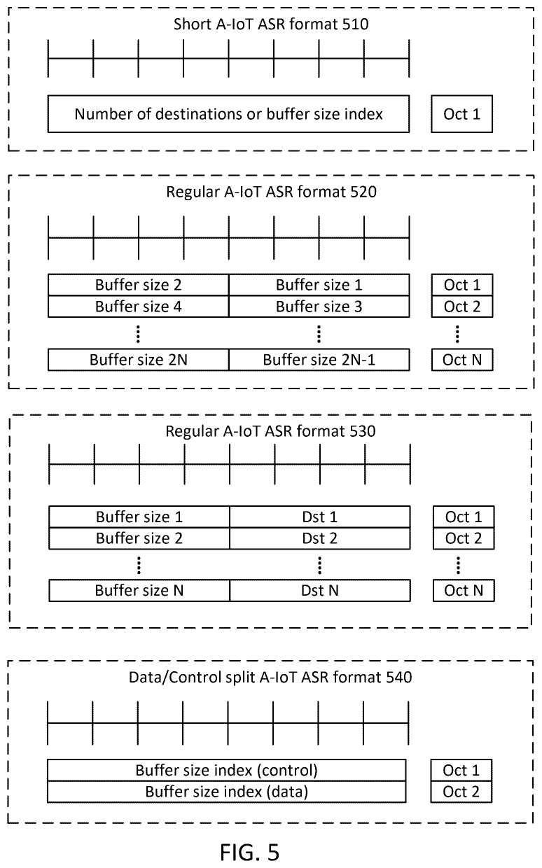

FIG. 5 illustrates control signaling formats in accordance with some embodiments. In some embodiments, UE 104 may send ASR in a MAC control element (CE). The MAC CE may include one or more buffer status reports of destination devices.

For case A scheme of FIG. 4 described above, e.g., unicast transmission, one or more buffer statuses may be included in the ASR using one of the following three options, e.g., options 1-3.

In option 1, a single report of the number of destination devices for which the UE 104 has outstanding buffered data is included in the ASR. ASR may include a bit field, and the value of the bit field may indicate the number of devices with buffered data at the UE 104. For example, short A-IoT ASR format 510 includes one octet to indicate the number of destinations.

In option 2, the ASR may include buffer size for each destination device without the destination device index included. Not including the device index or identifier may be beneficial in reducing the signaling overhead. For example, the regular A-IoT ASR format 520 may include a first bit field, e.g., K bits, to indicate the buffer size of a first destination device, a second bit field to report the buffer size of a second destination device, etc. In regular A-IoT ASR format 520, each octet is used to report the buffer size of two devices; e.g., 4 bits are used for each buffer size. With a total N octet used for reporting buffer size, a total of 2N buffer sizes may be reported. In some instances, only non-zero values are being reported, e.g., all the reported buffer sizes indicate a non-zero value, and destinations with no data are not reported. In some instances, the reported buffer size may indicate no data or a buffer size of zero (bits or bytes).

Base station 108 may adjust the allocated resource size for R2D transmission based on the reported buffer sizes. In some instances, the R2D transmission may use resources in a physical reader-to-device channel (PRDCH), which is a physical downlink data channel.

In option 3, the ASR may include buffer size for each destination device with the destination device index or identifier included. For example, regular A-IoT ASR format 530 may include a bit field to indicate the device destination index and an associated bit field to indicate the buffer size associated with that device. The device destination index field may be an indicator so that base station 108 can determine which device has more data to report when compared with other devices. The device index may also be configured by base station 108 by an RRC message for a known device (e.g., a report by a UE 104 reader to device 106). Option 3 is beneficial for accurate scheduling and resource allocation.

For the case B scheme of FIG. 4 described above, e.g., broadcast transmission, buffer status reports may not need to differentiate among destination devices. The buffer status report may be included in the ASR using one of the following three options, e.g., options 4-6.

In option 4, the ASR may report a single buffer status, including the buffer size of the A-IoT data buffered for R2D. ASR may include a bit field, and the value of the bit field may indicate the total buffer size of the A-IoT buffered data at the UE 104. For example, short A-IoT ASR format 510 may include one octet to indicate the buffer size index. The value of the buffer size index may indicate a buffer size value or a buffer size range.

In option 5, the ASR may include two buffer statuses: control PDU buffer size and data PDU buffer size. For example, data/control split A-IoT ASR format 540 may include a bit field to indicate the buffer size of control traffic and another bit field to indicate the buffer size of data traffic. In some instances, one octet may be allocated for the control PDU buffer size index, and one octet may be allocated for the data PDU buffer size index. The value of the control or data buffer size index may indicate the buffer size (in bits or bytes) or a range. In one instance, one buffer status report may be for paging messages and the other for downlink data other than paging messages.

In option 6, the UE 104 may be configured with a logical channel (LCH) or a logical channel group (LCG) for A-IoT traffic. For example, base station 108 may configure UE 104, e.g., via radio resource control (RRC) configuration, with an LCG for A-IoT traffic. UE 104 may report a single buffer status of the A-IoT data buffered for R2D associated with the configured LCG. The ASR associated with the configured LCG may use any of the ASR formats 510, 520, 530, or 540. For example, the ASR may include a short A-IoT ASR format 510 to indicate the number of destinations or the total buffer size index.

In some embodiments, the ASR associated with the configured channel may have the same priority as side-link (SL) BSR in the logical channel prioritization procedure among uplink traffic. In some instances, the ASR associated with the configured channel may have a priority lower than the SL BSR. In case of collision between different scheduled uplink transmissions, the transmission of the one with higher priority is prioritized, and it may be transmitted, and the one with lower priority may use remaining resources (not used by the high priority transmission) or may be dropped.

In some embodiments, base station 108 may configure the LCG for A-IoT traffic in the A-IoT configuration information element (IE) of the RRC configuration. Alternatively or additionally, the LCH index may be fixed in the 3GPP specifications, e.g., LCG #7 may always be used by relay UE 104 (intermediate UE 104) for ASR.

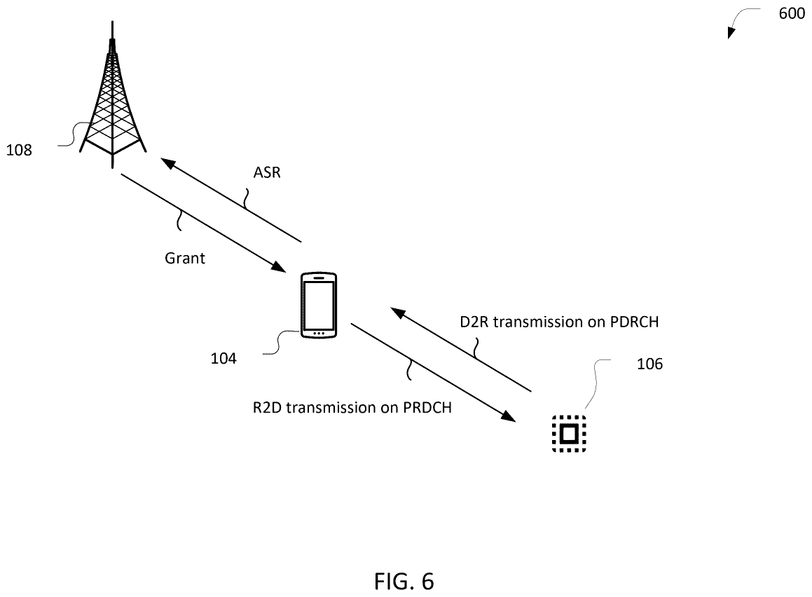

FIG. 6 illustrates a network environment 600 in accordance with some embodiments. Network environment 600 is an example of network environment 100 in FIG. 1.

The UE 104 may receive data from core network 112 or may self-generate data for transmission to the A-IoT device 106. As described above, the UE 104 may send the ASR to base station 108 to request scheduling (e.g., resources) for R2D transmission. Base station 108, in response to ASR, may generate and send the grant. The grant may be an R2D grant allocating resources for R2D transmission of buffered data at the UE 104.

In some instances, the R2D transmission from UE 104 to device 106 may trigger D2R traffic from device 106 to UE 104 (with UE 104 or core network 112 as the destination). The D2R traffic may go through the A-IoT air interface to reach UE 104 and through the Uu interface to reach base station 108 and subsequently to the core network 112.

In some embodiments, the uplink resources in the physical device-to-reader channel (PDRCH) may be directly linked to the downlink R2D transmission on PRDCH. For example, the time or frequency resources for the D2R transmission on PDRCH may be linked to the time or frequency resources of the R2D transmission on PRDCH that is scheduled by the grant sent by base station 108.

In some embodiments, UE 104 may explicitly request that base station 108 schedule D2R transmission. UE 104 may include information, e.g., a flag, in the ASR to indicate a request to schedule D2R transmission. The flag may be a bit field in ASR, e.g., 1, 2, or 4 bits. Base station 108, in response to the flag in the ASR, may include a D2R grant in the grant. UE 104 may share the D2R grant with device 106 in its R2D transmission to device 106. Device 106 may use the explicit uplink D2R grant to send its response or data to the UE 104 on the A-IoT air interface.

In some instances, when the flag is not included in the ASR or when the flag's value indicates that no D2R grant is being requested, it may indicate that device 106 may derive the uplink D2R transmission resource with a default algorithm. For example, device 106 may apply a configured offset to the timing of R2D transmission to obtain the timing of D2R transmission. Device 106 may use a configured uplink frequency associated with the downlink frequency of the R2D.

In some embodiments, the D2R grant is allocated by base station 108 based on the ASR, and the D2R grant is encapsulated in the NAS container and sent to device 106.

As described above, when UE 104 self-generates traffic or receives traffic from core network 112 to be delivered to device 106, UE 104 may trigger the generation and transmission of the ASR. In some embodiments, UE 104 may determine a condition and cancel the generation or transmission of the ASR. When ASR generation or transmission is triggered, it may be considered pending until it is fulfilled, e.g., generated and transmitted or canceled.

In some instances, UE 104 may cancel the ASR when the A-IoT MAC layer determines that an R2D grant in the A-IoT air interface is allocated by the serving gNB that is large enough to contain all buffered data to be sent to the A-IoT device 106. UE 104 may cancel ASR when the Uu uplink MAC PDU includes an ASR MC CE, which contains buffer status up to (and including) the last event that triggered an ASR prior to the MAC PDU assembly. UE 104 may cancel ASR when UE 104 determines that another ASR associated with the buffered data has been previously sent to base station 108.

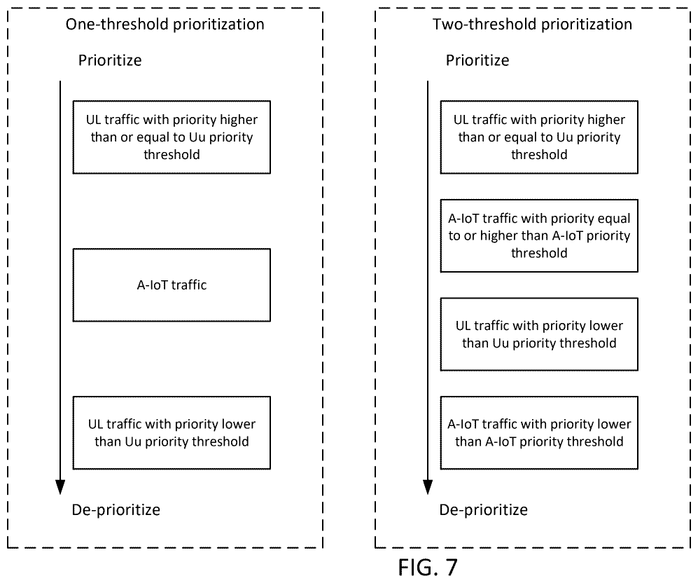

FIG. 7 illustrates two prioritization rules in accordance with some embodiments. A collision occurs when UE 104 has an uplink grant and an R2D grant with overlapping schedules or resources. When UE 104 cannot perform uplink and R2D transmission, e.g., when UE 104 has a single transceiver chain, UE 104 may choose one grant to use.

The first prioritization rule in FIG. 7 is the one-threshold prioritization. UE 104 may determine whether the uplink traffic associated with the uplink grant has a priority that is larger than a threshold. If the uplink traffic has a priority that is greater than or equal to the threshold, UE 104 may select the uplink grant and transmit the uplink traffic. UE 104 may drop the A-IoT R2D transmission. If UE 104 determines that the uplink traffic has a priority less than the threshold, UE 104 may select the A-IoT grant and transmit the A-IoT R2D traffic.

In one-threshold prioritization, base station 108 may configure UE 104 with the threshold. For example, the threshold may be an uplink-prioritization threshold configured by the base station 108, e.g., by RRC signaling, such as an RRC reconfiguration message. In some instances, the threshold may be specified by the 3GPP TSs.

The second prioritization rule in FIG. 7 is the two-threshold prioritization. UE 104 may determine whether the uplink traffic associated with the uplink grant has a priority that is larger than a threshold. If the uplink traffic has a priority that is greater than or equal to the threshold, UE 104 may select the uplink grant and transmit the uplink traffic. UE 104 may drop the A-IoT R2D transmission.

If UE 104 determines that the uplink traffic has a priority less than the threshold, UE 104 may determine whether the A-IoT traffic associated with the R2D grant has a priority that is larger than an A-IoT threshold. If UE 104 determines that the A-IoT traffic has a priority that is larger than or equal to the A-IoT threshold, UE 104 may select the R2D grant and transmit the R2D traffic. If UE 104 determines that the uplink traffic has a priority less than the threshold and the R2D traffic has a priority less than the A-IoT threshold, UE 104 may select that uplink grant and transmit the uplink traffic.

In two-threshold prioritization, base station 108 may configure UE 104 with the threshold and the A-IoT threshold. For example, the threshold may be an uplink-prioritization threshold, and the A-IoT threshold may be an A-IoT-prioritization-threshold configured by the base station 108, e.g., by RRC signaling such as RRC reconfiguration message. In some instances, the threshold or the A-IoT threshold may be specified by the 3GPP TSs.

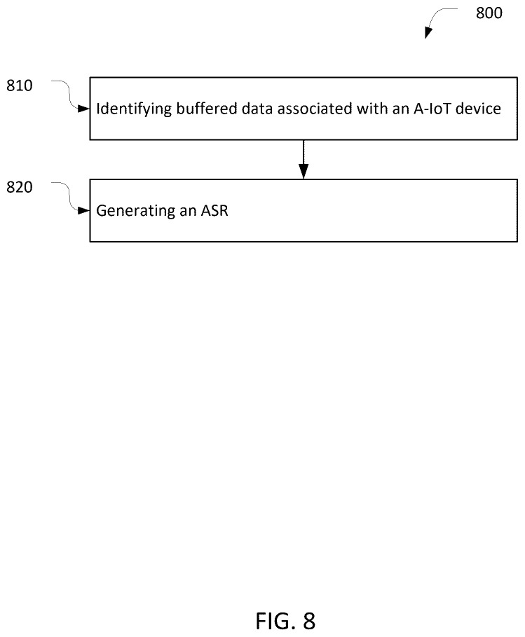

FIG. 8 illustrates an operation flow/algorithmic structure 800 in accordance with some embodiments. The operation flow/algorithmic structure 800 may be performed or implemented by a UE such as, for example, the UE 104 or UE 1000; or components thereof, for example, baseband processor circuitry 1004A.

The operation flow/algorithmic structure 800 may include, at 810, identifying buffered data associated with A-IoT device 106. UE 104 may receive and buffer data for A-IoT device 106 from core network 112 on NAS containers. UE 104 may self-generate and buffer data for A-IoT device 106. Identifying buffered data for A-IoT device 106 may trigger the generation and transmission of an ASR.

The operation flow/algorithmic structure 800 may include, at 820, generating an ASR. UE 104 may generate and transmit an ASR to base station 108. Base station 108 may receive and process the ASR.

In response to processing the ASR, base station 108 may generate and transmit an R2D grant to UE 104. R2D grant may schedule transmission from UE 104 to A-IoT device 106. R2D grant may indicate time or frequency resources for R2D transmission. UE 104 may use PRDCH for R2D transmission.

Transmission of buffered data to A-IoT device 106 may trigger a transmission, e.g., a response, by the A-IoT device 106. ASR may include a flag to indicate a request for a D2R grant. In response to the flat of ASR, base station 108 may generate a D2R grant. In some instances, base station 108 may send the D2R grant to UE 104, and UE 104 may send the D2R grant to the A-IoT device 106, e.g., in the R2D transmission. Alternatively or additionally, base station 108 may include the D2R grant in the payload or data transmitted to the A-IoT device 106 via NAS containers.

The ASR may be a MAC CE. The ASR may include an indication of a size of the buffered data. UE 104 may use a physical uplink control channel (PUCCH), physical uplink shared channel (PUSCH), or physical random-access channel (PRACH) to transmit the MAC CE containing the ASR.

UE 104 may determine a condition to cancel the generation or transmission of the ASR and cancel the generation or transmission of the ASR based on such determination. In one example, the condition for canceling generation or transmission ASR may be determining that a currently scheduled R2D transmission grant is large enough to contain the buffered data associated with the A-IoT device 106. In one example, the condition may be determining that another ASR associated with the buffered data was previously transmitted to the base station.

UE 104 may identify that there are buffered data for more than one A-IoT device. In one example, UE 104 may perform a unicast transmission to each A-IoT device or may perform a broadcast transmission that multiplexes buffered data of several A-IoT devices.

Base station 108 may configure UE 104 with an LCH or LCG and associate ASR with the configured LCH or LCG. For example, base station 108 may configure the LCH or LCG via RRC signaling. In another example, 3GPP TSs may specify the association between the ASR and a specific LCH or LCG, e.g., LCG #X.

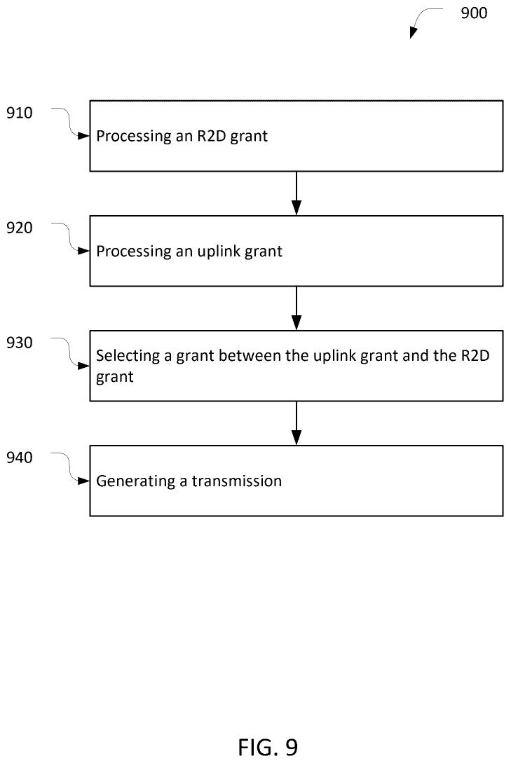

FIG. 9 illustrates an operation flow/algorithmic structure 900 in accordance with some embodiments. The operation flow/algorithmic structure 900 may be performed or implemented by a UE such as, for example, the UE 104 or UE 1000; or components thereof, for example, baseband processor circuitry 1004A.

The operation flow/algorithmic structure 900 may include, at 910, processing an R2D grant. UE 104 may receive and process the R2D grant transmitted by base station 108. The R2D grant may include resources for carrying the buffered data (e.g., user plane or control plane data) for the A-IoT device 106.

The operation flow/algorithmic structure 900 may include, at 920, processing an uplink grant. UE 104 may receive and process the uplink grant transmitted by base station 108. The uplink grant may include resources for carrying uplink data (e.g., user plane or control plane data) to the base station.

UE 104 may determine a collision between the uplink and R2D grants. For example, UE 104 may determine that the schedule of uplink transmission and R2D transmission overlap, e.g., in time or frequency resources.

The operation flow/algorithmic structure 900 may include, at 930, selecting a grant between the uplink grant and the R2D grant.

The operation flow/algorithmic structure 900 may include, at 940, generating a transmission based on the selected grant.

In a one-threshold prioritization, UE 104 may determine whether uplink traffic associated with the uplink grant has a priority greater than or equal to a threshold. Based on determining that the uplink traffic has a priority greater than or equal to the threshold, UE 104 may prioritize the uplink traffic and select the uplink grant. UE 104 may generate the transmission with the prioritized uplink traffic.

Based on determining that the uplink traffic has a priority less than the threshold, UE 104 may prioritize the A-IoT traffic associated with the R2D grant, select the R2D grant, and generate the transmission with the A-IoT traffic.

The threshold of one-threshold prioritization may be configured by the base station 108. Base station 108 may use RRC signaling, e.g., RRC reconfiguration message, to configure the threshold.

In a two-threshold prioritization, UE 104 may determine whether uplink traffic associated with the uplink grant has a priority greater than or equal to a first threshold. UE 104 may determine whether the A-IoT traffic associated with the R2D grant has a priority greater than or equal to a second threshold. Based on the determination that the uplink traffic has a priority greater than or equal to the first threshold, UE 104 may prioritize the uplink transmission over the R2D transmission and select the uplink grant.

Based on the determination that the uplink traffic has a priority less than the first threshold and that the A-IoT traffic has a priority greater than or equal to the second threshold, UE 104 may prioritize the A-IoT traffic and select the R2D grant. UE 104 may generate the transmission based on the prioritized A-IoT traffic.

Based on the determination that the uplink traffic has a priority less than the first threshold and that the A-IoT traffic has a priority less than the second threshold, UE 104 may prioritize the uplink traffic and select the uplink grant. UE 104 may generate the transmission based on the prioritized uplink traffic.

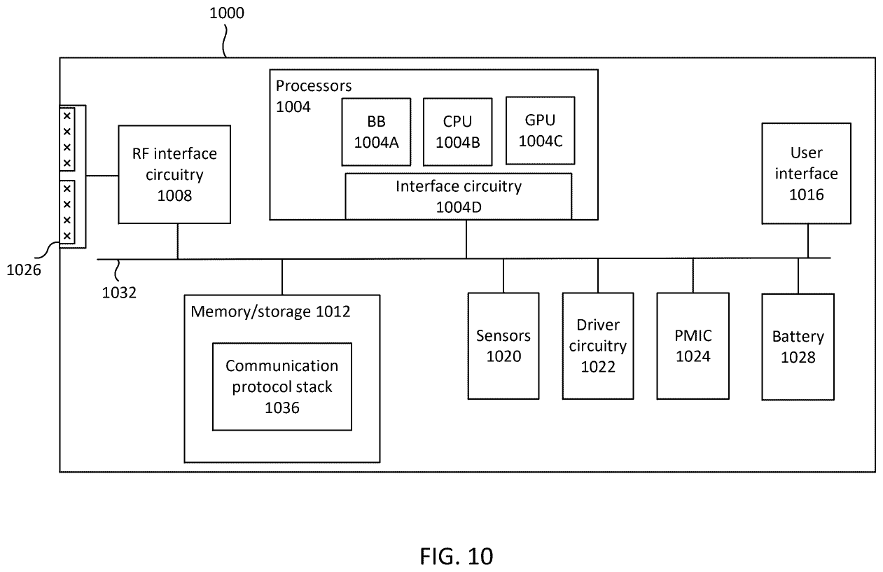

FIG. 10 illustrates a UE 1000 in accordance with some embodiments. The UE 1000 may be similar to and substantially interchangeable with the UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry, or processor circuitry that executes or otherwise operates computer-executable instructions, such as program code, software modules, or functional processes from memory/storage 1012 to cause the UE 1000 to perform operations as described herein. The processors 1004 may also include interface circuitry 1004D to enable communication by, for example, communicatively coupling the processor circuitry with one or more other components of the UE 1000.

In some embodiments, the baseband processor circuitry 1004A may access a communication protocol stack 1036 in the memory/storage 1012 to communicate over a 3GPP-compatible network. In general, the baseband processor circuitry 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The memory/storage 1012 may include one or more non-transitory, computer-readable media that include instructions (for example, communication protocol stack 1036) that may be executed by one or more of the processors 1004 to cause the UE 1000 to perform various operations described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor circuitry 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands, including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within or connected to the UE 1000. For example, driver circuitry 1022 may include a display driver to control and allow access to a display device, a touchscreen driver to control and allow access to a touchscreen interface, sensor drivers to obtain sensor readings of sensors 1020, and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples, the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

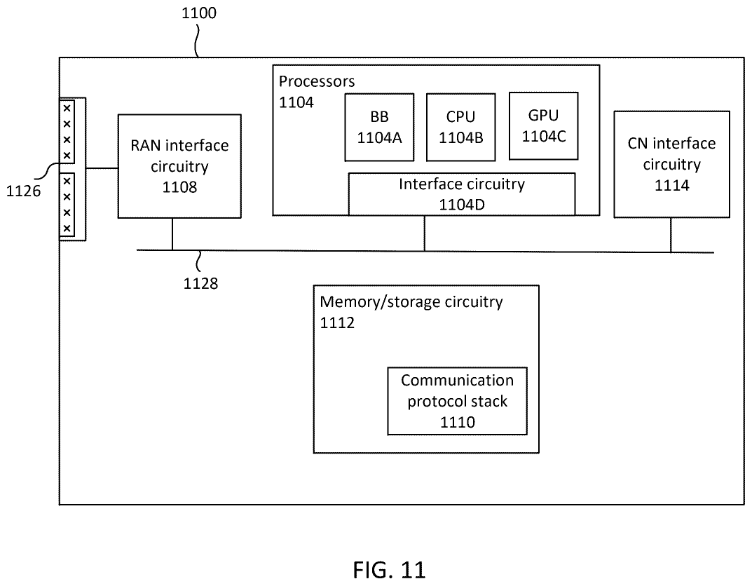

FIG. 11 illustrates a network device 1100 in accordance with some embodiments. The network device 1100 may be similar to and substantially interchangeable with base station 108.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry, or processor circuitry that executes or otherwise operates computer-executable instructions, such as program code, software modules, or functional processes from memory/storage circuitry 1112 to cause the UE 1000 to perform operations as described herein. The processors 1104 may also include interface circuitry 1104D to communicatively couple the processor circuitry with one or more other components of the network device 1100.

The CN interface circuitry 1114 may provide connectivity to a core network, for example, a 5th Generation Core network (5GC) using a 5GC-compatible network interface protocol such as carrier Ethernet protocols or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: identifying buffered data associated with an ambient Internet-of-things (A-IoT) device; and generating an A-IoT scheduling request (ASR) to be transmitted to a base station on a first channel.

Example 2 includes the method of example 1 or some other examples herein, wherein the ASR includes an indication of a size of buffered data.

Example 3 includes the method of examples 1 or 2 or some other examples herein, wherein the ASR includes a flag to indicate a request for a device-to-reader (D2R) grant.

Example 4 includes the method of any of examples 1-3 or some other examples herein, further including: determining a condition to cancel a transmission of the ASR; and canceling the transmission of the ASR based on said determining the condition.

Example 5 includes the method of any of examples 1-4 or some other example herein, wherein said determining the condition includes: determining that an uplink grant is large enough to contain the buffered data associated with the A-IoT device; or determining that an other ASR associated with the buffered data was previously transmitted to the base station.

Example 6 includes the method of any of examples 1-5 or some other examples herein, further including: processing a configuration including a logical channel group (LCG) designated for A-IoT; and assigning the ASR to the LCG.

Example 7 includes the method of any of examples 1-6 or some other examples herein, further including: processing a configuration including a priority associated with the LCG.

Example 8 includes the method of any of examples 1-7 or some other examples herein, wherein the priority is equal to a priority of a side-link buffer status report.

Example 9 includes the method of any of examples 1-8 or some other example herein, further including: processing a reader-to-device (R2D) grant received from the base station, the R2D grant to indicate resources for a transmission to carry the buffered data to the A-IoT device; and generating the transmission to be transmitted to the A-IoT device on a second channel.

Example 10 includes the method of any of examples 1-9 or some other example herein, wherein: the first channel is a physical uplink control channel (PUCCH), a physical uplink shared channel (PUSCH), or a physical random access channel (PRACH); and the second channel is a physical reader-to-device channel (PRDCH).

Example 11 includes the method of any of examples 1-10 or some other example herein, wherein the A-IoT device is a first A-IoT device, the buffered data is a first buffered data associated with the first A-IoT device, and the method further includes: identifying second buffered data associated with a second A-IoT device.

Example 12 includes the method of any of examples 1-11 or some other example herein, wherein the R2D grant is a first R2D grant, the resources are first resources, the transmission is a first transmission to the first A-IoT device, and the method further includes: processing a second R2D grant to indicate second resources for a second transmission to carry the second buffered data; and generating the second transmission to be transmitted to the second A-IoT device.

Example 13 includes the method of any of examples 1-12 or some other examples herein, wherein the ASR indicates a number of devices with buffered data.

Example 14 includes the method of any of examples 1-13 or some other examples herein, wherein the ASR indicates a first buffer size for the first A-IoT device; and a second buffer size for the second A-IoT device.

Example 15 includes the method of any of examples 1-14 or some other examples herein, wherein the ASR includes a first index associated with the first A-IoT device and a second index associated with the second A-IoT device.

Example 16 includes the method of any of examples 1-15 or some other examples herein, wherein the transmission includes the first data and the second data and is transmitted to the first and second A-IoT devices.

Example 17 includes the method of any of examples 1-16 or some other examples herein, wherein the ASR includes a buffer status of the first and second buffered data.

Example 18 includes the method of any of examples 1-17 or some other examples herein, wherein the ASR includes a first buffer status for control protocol data unit (PDU) buffer size and a second buffer status for data PDU buffer size.

Example 19 includes the method of any of examples 1-18 or some other example herein, wherein the transmission is a first transmission, the R2D grant includes an indication of a device-to-reader (D2R) grant, and method further includes: generating the first transmission to include the indication of the D2R grant; and processing a second transmission, received from the A-IoT device, on resources indicated by the D2R grant.

Example 20 includes a method including: processing a reader-to-device (R2D) grant received from a base station, the R2D grant to indicate resources for a transmission to carry buffered data to an ambient Internet-of-things (A-IoT) device processing an uplink grant received from the base station; and selecting, based on a prioritization rule, a grant between the uplink grant and the R2D grant.

Example 21 includes the method of example 20 or some other examples herein, further including: determining, based on the prioritization rule, that uplink traffic associated with the uplink grant has a priority greater than or equal to a threshold; and prioritizing the uplink traffic associated with the uplink grant with the priority over an A-IoT traffic associated with the R2D grant.

Example 22 includes the method of examples 20 or 21 or some other examples herein, wherein said selecting a grant between the uplink grant and the R2D grant comprises selecting the uplink grant.

Example 23 includes the method of any of examples 20-22 or some other examples herein, further including: determining, based on the prioritization rule, that uplink traffic associated with the uplink grant has a priority less than a threshold; and prioritized an A-IoT traffic associate with the R2D grant over the uplink traffic associated with the uplink grant.

Example 24 includes the method of any of examples 20-23 or some other examples herein, wherein said selecting a grant between the uplink grant and the R2D grant comprises selecting the R2D grant.

Example 25 includes the method of any of examples 20-24 or some other examples herein, further includes: determining that uplink traffic associated with the uplink grant has a priority less than or equal to a first threshold; determining that A-IoT traffic associated with the R2D grant has a priority greater than or equal to a second threshold; and prioritize the A-IoT traffic over the uplink traffic.

Example 26 includes the method of any of examples 20-25 or some other examples herein, wherein said selecting a grant between the uplink grant and the R2D grant comprises selecting the R2D grant.

Example 27 includes the method of any of examples 20-26 or some other examples herein, further including: determining that uplink traffic associated with the uplink grant has a priority less than or equal to a first threshold; determining that A-IoT traffic associated with the R2D grant has a priority less than a second threshold; and prioritize the uplink traffic over the A-IoT traffic.

Example 28 includes the method of any of examples 20-27 or some other examples herein, wherein said selecting a grant between the uplink grant and the R2D grant comprises selecting the uplink grant.

Another example may include an apparatus comprising means to perform one or more elements of a method described in or related to any of examples 1-28, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Another example may include an apparatus comprising logic, modules, or circuitry to perform one or more elements of a method described in or related to any of examples 1-28, or any other method or process described herein.

Another example may include a method, technique, or process as described in or related to any of examples 1-28, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-28, or portions thereof.

Another example may include a signal as described in or related to any of examples 1-28, or portions or parts thereof.

Another example may include a datagram, information element, packet, frame, segment, PDU, or message as described in or related to any of examples 1-28, or portions or parts thereof, or otherwise described in the present disclosure.

Another example may include a signal encoded with data as described in or related to any of examples 1-28, or portions or parts thereof, or otherwise described in the present disclosure.

Another example may include a signal encoded with a datagram, IE, packet, frame, segment, PDU, or message as described in or related to any of examples 1-28, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Another example may include a computer program comprising instructions, wherein execution of the program by a processing element is to cause the processing element to carry out the method, techniques, or process as described in or related to any of examples 1-28 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying buffered data associated with an ambient Internet-of-things (A-IoT) device; and
generating, based on identifying the buffered data, an A-IoT scheduling request (ASR) to be transmitted to a base station.

2. The method of claim 1, wherein the ASR includes an indication of a size of the buffered data.

3. The method of claim 1, wherein the ASR includes information to indicate a request for a device-to-reader (D2R) grant.

4. The method of claim 1, wherein the ASR is a first ASR and the buffered data is first buffered data, and wherein the method further comprises:
determining a condition to cancel a transmission of a second ASR associated with second buffered data of the A-IoT device, wherein said determining the condition comprises:
determining that a reader-to-device (R2D) grant is large enough to contain the second buffered data; or
determining that another ASR associated with the second buffered data was previously transmitted to the base station; and
canceling the transmission of the second ASR based on said determining the condition.

5. The method of claim 1, further comprising:
processing a configuration including a logical channel group (LCG) designated for A-IoT;
assigning the ASR to the LCG; and
determining a priority associated with the ASR based on the LCG.

6. The method of claim 5, wherein the priority is equal to a priority of a side-link buffer status report.

7. The method of claim 1, wherein the ASR is to be transmitted on a physical uplink control channel (PUCCH) or a physical uplink shared channel (PUSCH), and wherein the method further comprises:
processing a reader-to-device (R2D) grant received from the base station, the R2D grant to indicate resources for a transmission to carry the buffered data to the A-IoT device; and
generating the transmission to be transmitted to the A-IoT device on a physical reader-to-device channel (PRDCH).

8. The method of claim 7, wherein the A-IoT device is a first A-IoT device, the buffered data is first buffered data associated with the first A-IoT device, the R2D grant is a first R2D grant, the resources are first resources, the transmission is a first transmission to the first A-IoT device, and wherein the method further comprises:
identifying second buffered data associated with a second A-IoT device;
processing a second R2D grant to indicate second resources for a second transmission to carry the second buffered data; and
generating the second transmission to be transmitted to the second A-IoT device.

9. The method of claim 8, wherein:
the ASR indicates a number of devices with buffered data;
the ASR indicates a first buffer size for the first A-IoT device and a second buffer size for the second A-IoT device; or
the ASR includes a first index associated with the first A-IoT device and a second index associated with the second A-IoT device.

10. The method of claim 7, wherein the A-IoT device is a first A-IoT device, the buffered data is first buffered data associated with the first A-IoT device, and wherein the method further comprises:
identifying second buffered data associated with a second A-IoT device, wherein the transmission includes the first buffered data and the second buffered data and is transmitted to the first and second A-IoT devices.

11. The method of claim 10, wherein the ASR includes a buffer status of the first and second buffered data, and wherein the buffer status includes a first buffer status for a control protocol data unit (PDU) buffer size and a second buffer status for a data PDU buffer size.

12. The method of claim 7, wherein the transmission is a first transmission, the R2D grant includes an indication of a device-to-reader (D2R) grant, and the method further comprises:
generating the first transmission to include the indication of the D2R grant; and
processing a second transmission, received from the A-IoT device, on resources indicated by the D2R grant.

13. A method comprising:
processing a reader-to-device (R2D) grant received from a base station, the R2D grant indicating first resources for carrying buffered data to an ambient Internet-of-things (A-IoT) device;
processing an uplink grant received from the base station, the uplink grant indicating second resources for carrying data to the base station;
selecting, based on a prioritization rule, a grant between the uplink grant and the R2D grant; and
generating a message for transmission based on the grant.

14. The method of claim 13, further comprising:
determining, based on the prioritization rule, that uplink traffic associated with the uplink grant has a priority greater than or equal to a threshold;
prioritizing the uplink traffic associated with the uplink grant with the priority over an A-IoT traffic associated with the R2D grant; and
generating the message with the uplink traffic based on said prioritizing the uplink traffic, wherein said selecting a grant between the uplink grant and the R2D grant comprises selecting the uplink grant.

15. The method of claim 13, further comprising:
determining, based on the prioritization rule, that uplink traffic associated with the uplink grant has a priority less than a threshold;
prioritizing an A-IoT traffic associated with the R2D grant over the uplink traffic associated with the uplink grant; and
generating the message with the A-IoT traffic based on said prioritizing the A-IoT traffic, wherein said selecting a grant between the uplink grant and the R2D grant comprises selecting the R2D grant.

16. The method of claim 13, further comprising:
determining that uplink traffic associated with the uplink grant has a priority less than or equal to a first threshold;
determining that A-IoT traffic associated with the R2D grant has a priority greater than or equal to a second threshold;
prioritizing the A-IoT traffic over the uplink traffic; and
generating the message with the A-IoT traffic based on said prioritizing the A-IoT traffic, wherein said selecting a grant between the uplink grant and the R2D grant comprises selecting the R2D grant.

17. The method of claim 13, further comprising:
determining that uplink traffic associated with the uplink grant has a priority less than or equal to a first threshold;
determining that A-IoT traffic associated with the R2D grant has a priority less than a second threshold;
prioritizing the uplink traffic over the A-IoT traffic; and
generating the message with the uplink traffic based on said prioritizing the uplink traffic, wherein said selecting a grant between the uplink grant and the R2D grant comprises selecting the uplink grant.

18. An apparatus comprising:
processor circuitry to:
identify buffered data associated with an ambient Internet-of-things (A-IoT) device; and
generate, for transmission to a base station and based on identifying the buffered data, an A-IoT scheduling request (ASR) that includes an indication of a size of the buffered data and a request for a device-to-reader (D2R) grant for the buffered data; and
interface circuitry coupled to the processor circuitry to enable communication.

19. The apparatus of claim 18, wherein the ASR is to be transmitted on a physical uplink control channel (PUCCH) or a physical uplink shared channel (PUSCH), and wherein the processor circuitry is further to:
process a reader-to-device (R2D) grant received from the base station, the R2D grant to indicate resources for a transmission to carry the buffered data to the A-IoT device; and
generate the transmission to be transmitted to the A-IoT device on a physical reader-to-device channel (PRDCH).

20. The apparatus of claim 19, wherein the A-IoT device is a first A-IoT device, the buffered data is first buffered data associated with the first A-IoT device, the R2D grant is a first R2D grant, the resources are first resources, the transmission is a first transmission to the first A-IoT device, and wherein the processor circuitry is further to:
identify second buffered data associated with a second A-IoT device;
process a second R2D grant to indicate second resources for a second transmission to carry the second buffered data; and
generate the second transmission to be transmitted to the second A-IoT device.
